(19) United States
(12) Patent Application Publication
(10) Pub. No.: US 2017/0180219 A1
(43) Pub. Date: Jun. 22, 2017

(54) SYSTEM AND METHOD OF ANALYZING USER SKILL AND OPTIMIZING PROBLEM DETERMINATION STEPS WITH HELPDESK REPRESENTATIVES

(71) Applicant: International Business Machines Corporation, Armonk, NY (US)

(72) Inventors: Tamer E. ABUELSAAD, Somers, NY (US); Gregory J. BOSS, Saginaw, MI (US); Brent HODGES, Raleigh, NC (US); John E. Moore, JR., Brownsburg, IN (US)

(21) Appl. No.: 14/972,641

(22) Filed: Dec. 17, 2015

(51) Int. Cl. H04L 12/24; H04L 12/26; G06F 17/30

(52) U.S. Cl. CPC H04L 41/5074; G06F 17/30528; H04L 43/04

(57) ABSTRACT

An information processing system, computer readable storage medium, and method for customizing helpdesk services according to a user's skill level. The method includes determining a problem resolution domain corresponding to a user of an information processing system solving a problem associated with using the information processing system; selectively recording user actions; determining, based on the recorded user actions, a helpdesk problem resolution procedure that matches the recorded user actions; aggregating the recorded user actions by converting them into completed steps in a helpdesk problem resolution procedure; and presenting to a helpdesk representative at least one of the steps, where completed steps are presented distinguished from the other steps in the procedure. A user skill level can be determined, based on analyzing the completed steps, and presented to the helpdesk representative for customizing helpdesk services according to the user's skill level.

### BACKGROUND

The present disclosure generally relates to information technology (IT) service helpdesk monitoring systems, and more particularly relates to a method and system for monitoring user actions relative to an IT service helpdesk function.

The IT service desk market is over $1.5 B. Almost every IT and retail company selling goods or services has a helpdesk for customers or employees to call into to receive support. One problem that almost every helpdesk has is applying customized service to customers with varying skill sets. Further complicating matters is that many helpdesks have low skilled employees or contractors staffing the facility who are not able to deviate from canned scripts. Too often a skilled customer calls in to report an issue, only to find the helpdesk representative can do nothing but read a script and is not able to understand or discern that a caller is highly skilled or has already performed many of the steps the representative is requiring that person to do. To avoid unskilled helpdesk representatives and to receive customized meaningful service often requires the customer asking for a supervisor or asking to be transferred to a level 2/3 person.

### BRIEF SUMMARY

According to one embodiment of the present disclosure, a method for customizing helpdesk services provided to an end user according to the user's skill level, the method comprising: determining, with a processor communicatively coupled to a memory, a problem resolution domain corresponding to a user of an information processing system solving a problem associated with using the information processing system; selectively recording user actions by storing in the memory a set of representations of the recorded user actions that are determined to be within the problem resolution domain and that occur with the information processing system being used by the user to solve a problem associated with using the information processing system; determining, based on the recorded user actions, a helpdesk problem resolution procedure that matches the recorded user actions, the determined helpdesk problem resolution procedure being selected from a set of helpdesk problem resolution procedures within the problem resolution domain, each of the set of helpdesk problem resolution procedures comprising a set of relevant steps to be completed for solving a problem within the problem resolution domain, a representation corresponding to each relevant step in the set of relevant steps of the determined helpdesk problem resolution procedure, being stored in a first memory of a first information processing system; aggregating the recorded user actions by converting the recorded user actions into completed one or more steps in a set of relevant steps in the determined helpdesk problem resolution procedure for solving a problem within the problem resolution domain, a completed flag being associated with each representation of the completed one or more steps stored in the first memory to indicate completed status of each of the one or more steps; and presenting to a helpdesk representative at least one relevant step of the set of relevant steps in the determined helpdesk problem resolution procedure, wherein the completed one or more steps being presented distinguished from the other steps in the set of relevant steps.

According to another embodiment of the present disclosure, an information processing system capable of customizing helpdesk services provided to an end user according to the user's skill level, the information processing system comprising: memory; persistent memory for storing data and computer instructions; at least one processor, communicatively coupled with the memory and the persistent memory; and a helpdesk monitoring agent, communicatively coupled with the processor, the memory, and the persistent memory, wherein the helpdesk monitoring agent being responsive to receiving user input indicating a user request to start selectively recording user actions and wherein the processor being responsive to executing the computer instructions, the processor performing the method comprising: determining, with the processor, a problem resolution domain corresponding to a user of the information processing system solving a problem associated with using the information processing system; selectively recording the user's actions by storing in the memory a set of representations of the recorded user actions that are determined to be within the problem resolution domain and that occur with the information processing system being used by the user to solve a problem associated with using the information processing system; determining, based on the recorded user actions, a helpdesk problem resolution procedure that matches the recorded user actions, the determined helpdesk problem resolution procedure being selected from a set of helpdesk problem resolution procedures within the problem resolution domain, each of the set of helpdesk problem resolution procedures comprising a set of relevant steps to be completed for solving a problem within the problem resolution domain, a representation corresponding to each relevant step in the set of relevant steps of the determined helpdesk problem resolution procedure being stored in the memory; aggregating the recorded user actions by converting the recorded user actions into completed one or more steps in a set of relevant steps in the determined helpdesk problem resolution procedure for solving a problem within the problem resolution domain, a completed flag being associated with each representation of the completed one or more steps stored in the memory to indicate completed status of each of the one or more steps; and sending one or more messages destined for reception by a helpdesk monitor in a helpdesk information processing system being separate from, and located across one or more networks relative to, the information processing system, the one or more messages including user-related information for presenting to a helpdesk representative for adapting helpdesk services corresponding to the determined helpdesk problem resolution procedure provided by the helpdesk representative to the user, the user-related information comprising: identification of the set of relevant steps in the determined helpdesk problem resolution procedure that matches the recorded user actions; and identification of one or more steps in the set of relevant steps that were completed by the user.

According yet to another embodiment of the present disclosure, a computer readable storage medium comprises computer instructions which, responsive to being executed by a processor, cause the processor to perform operations for customizing helpdesk services provided to an end user according to the user's skill level, the operations comprising: determining, with the processor being communicatively coupled to a memory of an information processing system, a problem resolution domain corresponding to a user of the information processing system solving a problem associated with using the information processing system; selectively recording user actions by storing in the memory a set of representations of the recorded user actions that are determined to be within the problem resolution domain and that occur with the information processing system being used by the user to solve a problem associated with using the information processing system; determining, based on the recorded user actions, a helpdesk problem resolution procedure that matches the recorded user actions, the determined helpdesk problem resolution procedure being selected from a set of helpdesk problem resolution procedures within the problem resolution domain, each of the set of helpdesk problem resolution procedures comprising a set of relevant steps to be completed for solving a problem within the problem resolution domain, a representation corresponding to each relevant step in the set of relevant steps of the determined helpdesk problem resolution procedure being stored in the memory; aggregating the recorded user actions by converting the recorded user actions into completed one or more steps in a set of relevant steps in the determined helpdesk problem resolution procedure for solving a problem within the problem resolution domain, a completed flag being associated with each representation of the completed one or more steps stored in the memory to indicate completed status of each of the one or more steps; and sending one or more messages destined for reception by a helpdesk monitor in a helpdesk information processing system being separate from, and located across one or more networks relative to, the information processing system, the one or more messages including user-related information for presenting to a helpdesk representative for adapting helpdesk services corresponding to the determined helpdesk problem resolution procedure provided by the helpdesk representative to the user, the user-related information comprising: identification of the set of relevant steps in the determined helpdesk problem resolution procedure that matches the recorded user actions; and identification of one or more steps in the set of relevant steps that were completed by the user, for presenting to the helpdesk representative the completed one or more steps distinguished from the other steps in the set of relevant steps.

Furthermore, in various embodiments, the processor performed operations comprise: analyzing, with the processor, the set of relevant steps in the determined helpdesk problem resolution procedure including those one or more steps that are determined to be completed by the user, and automatically determining a user skill level for the user based on measuring the accuracy and percentage of overlap of the completed one or more steps relative to all the relevant steps in the determined helpdesk problem resolution procedure; and wherein the user-related information in the one or more messages comprising: identification of the determined user skill level for presenting the determined user skill level to the helpdesk representative for adapting helpdesk services corresponding to the determined helpdesk problem resolution procedure.

### BRIEF DESCRIPTION OF THE SEVERAL VIEWS OF THE DRAWINGS

The accompanying figures, in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating an example of a helpdesk monitoring system, according to various embodiments of the present disclosure;

FIG. 2 is a block diagram illustrating an example of a wireless communication device in the helpdesk monitoring system of FIG. 1, according to various embodiments of the present disclosure;

FIG. 3 is a block diagram illustrating an example of a helpdesk information processing system in the helpdesk monitoring system of FIG. 1, according to various embodiments of the present disclosure;

FIG. 4 is a block diagram of an example message sent from a helpdesk monitoring agent operating on a user's computing device to a helpdesk information processing system, according to various embodiments of the present disclosure;

FIG. 5 is a flow diagram illustrating an example operational sequence with the wireless communication device of FIG. 1.

FIG. 6 is a flow diagram illustrating an example operational sequence with the helpdesk information processing system of FIG. 1.

FIG. 7 shows an example of aggregation of user recorded actions with the wireless communication device of FIG. 1.

FIGS. 8 to 10 show an example of analyzing and optimizing one or more sets of helpdesk problem resolution procedure steps based on determined user skills, according to various embodiments of the present disclosure.

### DETAILED DESCRIPTION

According to various embodiments of the present disclosure, disclosed is a system and method to programmatically ascertain a user's (i.e., a person's) skill level prior to or during a call to a helpdesk to solve a problem associated with the user. The system, for example, monitors actions a user is performing in her/his environment, including capturing keyboard and user interface (UI) actions taken by the user. One method, for example, involves selectively recording user actions based on actions that are already part of a set of helpdesk scripts (i.e., a set of helpdesk procedure steps). Another method, according to a second example, concatenates and summarizes user actions and analyzes metadata around those user actions including analyzing how long it took to perform the user actions, if a user taking those actions was following an online guide, if the user was following voice instructions from helpdesk personnel, or how many times the user has performed a particular task. Finally, the system rolls this captured user behavior (e.g., user activity), and any associated analysis, up to the helpdesk representative so that existing scripts (i.e., set of helpdesk procedure steps) can be modified (i.e., adapted) in real time to avoid unnecessary repeating of actions that have already occurred or that are moot having no significance or relevance under the particular circumstances. This adapting (or customizing) of helpdesk services provided to users results in such services being more accurate, more relevant to the particular user's skill level, and more efficient, thereby end users and customers will be more satisfied with such helpdesk services.

According to one embodiment of the present disclosure, a method is provided to selectively record a user's troubleshooting scripts (i.e., a set of helpdesk problem resolution procedure steps that are taken by the user) by monitoring for actions taken by the user and that are found in a helpdesk representative's library of scripts (i.e., one or more sets of helpdesk problem resolution procedure steps). For recording, this method is not necessarily like macro recording. A recording process can take various forms, for example such as the following two example forms.

A) In one example form, a helpdesk (HD) monitoring agent identifies for each topic (e.g., a topic could be Lotus Notes Issues) areas of troubleshooting problems such as for a computing device.

B) According to another example form, a helpdesk (HD) monitoring agent (e.g., a recording agent) records all actions taken by a user and highlights steps for the topic at hand, however, while other actions are recorded as well. The HD representative is able to view which ever part of the steps taken by the user, even if outside of specific scripts (i.e., one or more sets of helpdesk problem resolution procedure steps) for the topic at hand.

The HD information processing system can receive the recording from the HD monitoring agent and then can perform aggregation to the steps it receives. For example, if a user took the following steps:

1. Open My Computer

2. C:\

3. cd notes

4. cd data

5. rename user.id file user.id.old

The collection of steps would be converted to c:\notes\data\rename user.id user.id.old.

According to one example, the following steps would be taken in preparation for using a recording agent.

Preparation Steps:

1. User installs helpdesk monitoring agent software on a personal computer (PC) or other computing device, or the software can be preloaded in the PC or other computing device such as a smartphone.

2.User configures preferences (e.g., selective recording, allowed metadata, historical uploads) for the HD monitoring agent.

According to one example, the following steps would be taken in operations of a HD monitoring system that includes a HD information processing system for communicating with a recording HD monitoring agent at a user's PC or other computing device.

According to the example, the following steps would be taken in operations using the recording agent.

Operation Steps:

1. User selects, via a user interface of the user's PC or other computing device, a helpdesk monitoring agent and begins recording.

2. User performs troubleshooting steps using the user's PC or other computing device.

3. The helpdesk monitoring agent software monitors the actions taken by the user and determines if a monitored user action matches an action in a helpdesk problem resolution procedure script. Optionally the helpdesk monitoring agent software records all steps taken by the user, without regard to helpdesk script actions.

4. If a monitored action taken by the user matches an action found in a helpdesk script then the monitored action is logged and sent by the helpdesk monitoring agent software to a helpdesk information processing system.

5. User finishes troubleshooting and stops the recording by the helpdesk monitoring agent software.

6. User calls the helpdesk. The helpdesk, having previously collected the information received from the helpdesk monitoring agent software, can customize helpdesk scripts followed by helpdesk personnel (and accordingly customize helpdesk services provided to users by helpdesk representatives) thereby conforming and adapting the helpdesk services to the calling user's skill level, as will be discussed in more detail below.

Example of Assessing User Skill Level Based On Prior User Activity

Provided below is one example method that a helpdesk information processing system can perform to assess a user's skill level by analyzing how thoroughly the user has performed helpdesk script actions prior to the user calling the helpdesk.

This method, according to the present example, analyzes the actions a user took while the helpdesk monitoring agent was recording those actions. It then determines at least one helpdesk script that matches the actions taken by the user. The method determines the percentage of actions that overlap with steps in the helpdesk script. It also measures the accuracy of the order of those actions corresponding to steps taken by the user with regard to the order of the helpdesk script steps. Finally, the analysis takes into account the success rate of the user's troubleshooting (problem resolution) actions over time. The culmination of these analyses results in an assessment and identification of a skill level for the user. This is only one non-limiting example of assessing and identifying the skill level of the user in solving the problem according to the helpdesk script. There are many variations that can be taken in an approach to assessing the skill level of the user. For example, not all of the steps described above need to be taken to implement a variation of the present example method.

According to the present example, the method steps taken to assess a user's skill level by analyzing how thoroughly the user has performed helpdesk script actions can include the following.

1. User completed PDR (Problem Determination and Resolution) recording session.

2. System analyzes user's actions (accuracy, overlap, and success rate).

3. System applies any global weighting policies.

4. System determines which category the PDR session was related to.

5. System assigns a skill rating to the user and category.

6. System logs this information for the next time the user calls in to access the helpdesk.

Example of Pruning Helpdesk Procedure Steps Based On Prior User Activity

Provided below is one example method that a helpdesk information processing system can perform to automatically remove (i.e., prune) elements (e.g., steps) from a helpdesk problem resolution procedure script if the customer (e.g., the user) calling the helpdesk has already performed them. This method will automatically remove actions (or hide/highlight in some fashion) from a helpdesk problem resolution procedure that were performed previously by the end user and customer, thereby resulting in a modified helpdesk problem resolution procedure. The helpdesk information processing system determines which actions to prune after a user action recording session is uploaded from the recording agent to the helpdesk information processing system. The helpdesk information processing system optimizes the HD representative/customer session by removing HD problem resolution procedure steps that would be otherwise repetitive or moot having no significance or relevance under the particular circumstances.

According to the example, the method steps taken to automatically remove elements from a helpdesk troubleshooting script (i.e., a set of problem resolution procedure steps) can include the following.

1. Customer calls into the helpdesk.

2. System compares logs of customer's previous recorded session to an existing script.

3. System removes (or hides/highlights in some fashion) any collection of steps that were completed previously by the customer/user, or that are moot in view of the collection of previously recorded steps taken by the customer/user; thereby resulting in a modified helpdesk problem resolution procedure.

4. System marks removed steps with some visual indicator (e.g., a representation of completed steps) so the helpdesk representative is made aware of the changes to the helpdesk script for use with the particular customer.

Example of Constructing Helpdesk Procedure Steps Based On User Skill Level

Provided below is one example method that a helpdesk information processing system can perform to construct helpdesk procedure steps to make them more dynamic and customizable for an individual user's skill level.

1. Review a given helpdesk script (i.e., a set of helpdesk procedure steps).

2. For each step, identify the typical skill of a user who would perform that step before the user calls the helpdesk representative for assistance (i.e., weighting the step based on typical skill level to perform the step).

3. Identify groups of steps which must be executed as a whole to be meaningful (e.g., ipconfig/release, ipconfig/renew) (i.e., linking the identified steps in a group).

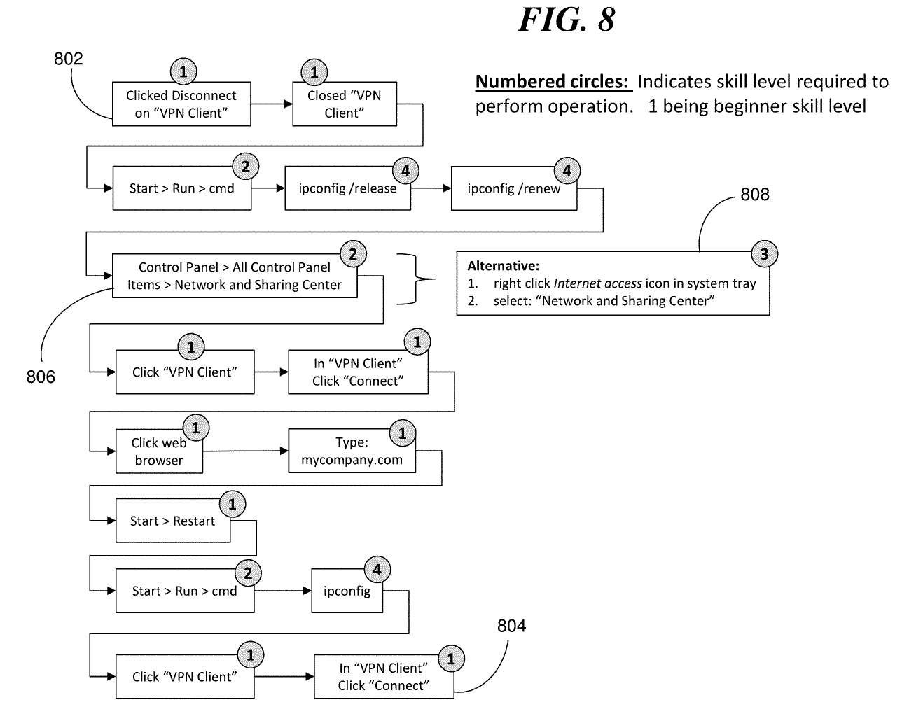

An example of the above grouping and assignment of skill levels to a set of helpdesk procedure steps is illustrated in FIG. 8. Note the numbered circles next to each procedure step which indicate, within a range of skill levels, the skill level required to perform the operation. A skill level of one is a beginner skill level. A skill level of four, on the other end of the range of skill levels, is an expert skill level.

A helpdesk system according to various embodiments of the present disclosure can include one or more of the following.

1. A method to selectively record a customer's troubleshooting scripts (problem resolution procedure) by monitoring for actions found in a helpdesk representative's library of scripts.

2. A method to assess a user's skill level by analyzing how thoroughly the user has performed helpdesk script actions prior to calling the helpdesk.

3. A method to automatically remove elements from a helpdesk troubleshooting script if the customer calling has already performed them.

With regard to list item 1 above, emphasis is made to the “selective” nature of the recording of the user's actions that are particularly relevant to a helpdesk problem resolution script. That is, the helpdesk problem resolution procedure or script comprises a set of relevant steps to be completed for solving a problem within a problem resolution domain. The helpdesk digital recording agent which sits on the user's PC or other computing device (e.g., accessible on the desktop of the PC or other computing device) can be configured by the helpdesk in advance with certain configuration parameters identifying specific topical areas that are handled by the helpdesk. For example, an IBM helpdesk may support Lotus Notes, Microsoft Windows 7, Linux, and Firefox. In this example, the helpdesk will define attributes of user actions taken on the user's PC or other computing device that should be recorded by the recording agent when a topical area is selected. If the user opens the recording agent and then picks “Troubleshoot Lotus Notes” then the recording agent will only record keystrokes and commands taken on the user's PC or other computing device that are related to Lotus Notes. The recording agent records only these certain actions taken as defined by the helpdesk configuration parameters configured by the helpdesk in advance on the user's PC or other computing device.

According to this example, the selective recording of user actions taken is then sent, as a customer troubleshooting (problem resolution) log in a log file, to the helpdesk information processing system after the end user has stopped troubleshooting a problem. The HD information processing system coordinates the delivery of this customer troubleshooting log to the IT personnel assigned to the end user who calls the helpdesk.

With regard to item 2 above, the HD information processing system, for example, can assess the user's skill level by determining how many steps the user performed of the known scripted helpdesk steps. The HD information processing system can then review the log and determine the user's skill level and how thoroughly that user understands the problem resolution procedure and related technology.

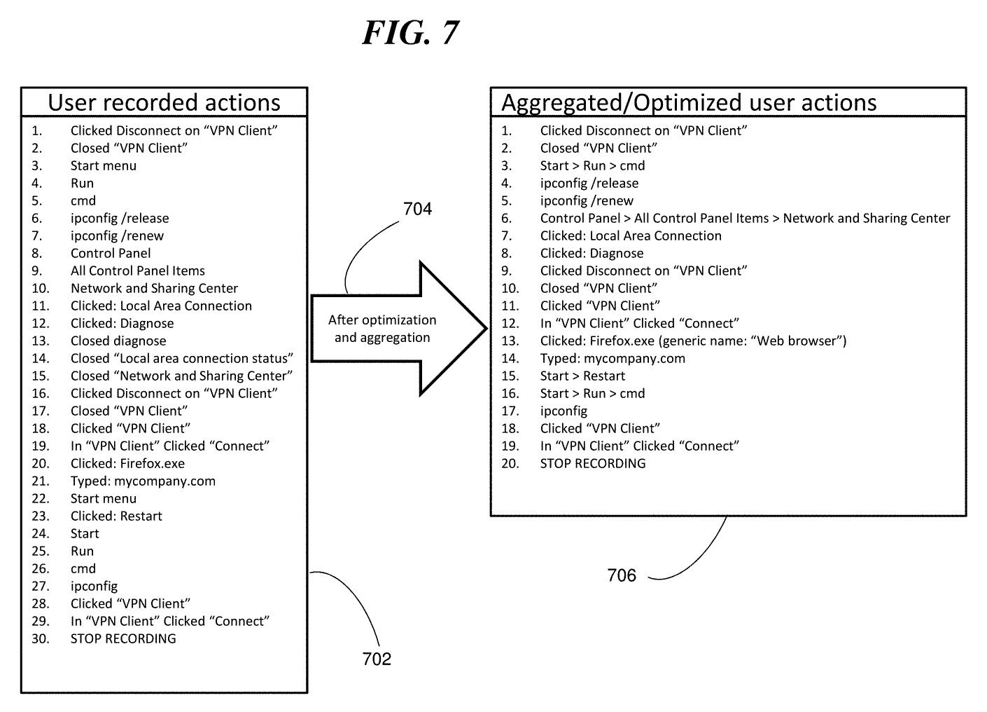

With regard to item 3 above, the HD information processing system prunes the log in the log file of less meaningful data. An example of a log before and after a pruning process is shown in FIG. 7.

Finally, according to the example, the HD information processing system compares the steps taken by the user to the steps in the HD problem resolution procedure script to determine the non-overlapping steps—i.e., those helpdesk scripted steps that remain to be taken. All of the collected and analyzed information, as discussed above, can then be provided to the HD personnel assigned to assist the user who calls the helpdesk.

A discussion of various embodiments of the present disclosure will be provided below illustrating in more detail several examples.

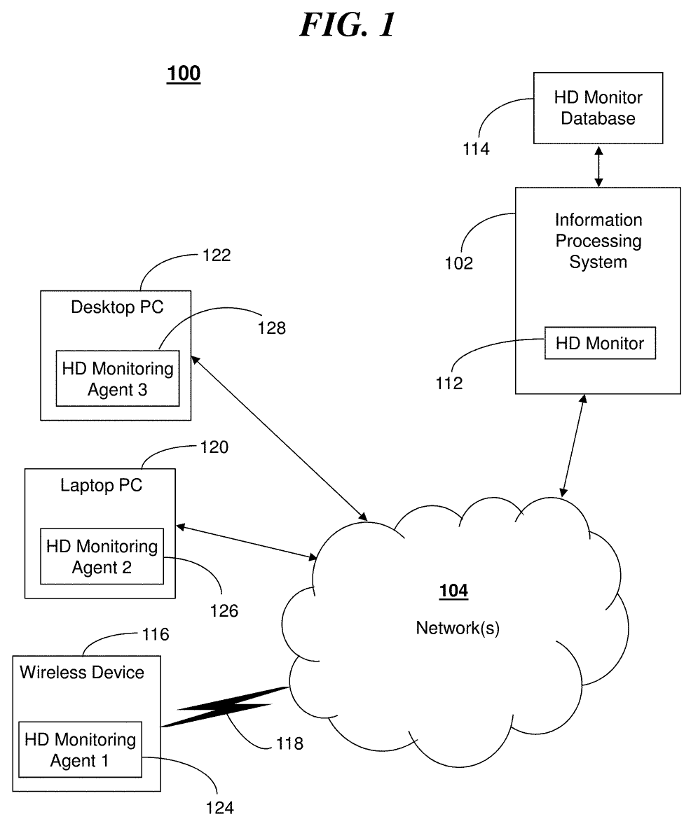

Referring to FIG. 1, an example of a helpdesk monitoring communication system 100 is shown, according to various embodiments of the present disclosure. An information processing system 102 comprises a helpdesk (HD) monitor 112, and is communicatively coupled with a HD monitor database 114, as will be discussed in more detail below.

The information processing system 102 is communicatively coupled to one or more networks 104. The one or more networks 104 can include wired and/or wireless networks, and can be any of local area networks, wide area networks, or a combination of such networks. For example, wide area networks including the Internet and the web can inter-communicate the information processing system 102 with other one or more information processing systems that are separate from the information processing system 102, and that may be locally, or remotely, located relative to the information processing system 102. It should be noted that mobile communications devices, such as mobile phones, Smart phones, tablet computers, lap top computers, and the like, which are capable of at least one of wired and/or wireless communication, are also examples of information processing systems within the scope of the present disclosure. As can be seen in the example of FIG. 1, a desktop personal computer (PC) 122, a laptop PC 120, and a wireless communication device (e.g., a mobile phone) 116, are illustrated communicatively coupled with the one or more networks 104. The wireless communication device 116 is shown communicatively coupled over a wireless network link 118.

The wireless communication device 116 comprises a first HD monitoring agent 124. The laptop PC 120 comprises a second HD monitoring agent 126. The desktop PC 122 comprises a third HD monitoring agent 126. The HD monitoring agents 124, 126, 128, can communicate over the networks 104 with the HD monitor 122 at the information processing system 102. A user may install such helpdesk monitoring agent software on the desktop PC 122, the laptop PC 120, and the wireless communication device 116, or the helpdesk monitoring agent software can be preloaded in the particular device 116, 120, 122.

Each monitoring agent 124, 126, 128, as has been discussed above, can record some or all actions taken by a user of the particular information processing system, such as the desktop PC 122, the laptop PC 120, and the wireless communication device 116, based on various methods followed according to various embodiments of the present disclosure. For example, the monitoring agent 124, 126, 128, can record actions taken by the user using the particular information processing system (e.g., the desktop PC 122, the laptop PC 120, and the wireless communication device 116), and which may include actions corresponding to one or more steps found in a helpdesk representative's library of scripts (i.e., one or more sets of helpdesk problem resolution procedure steps). The particular monitoring agent 124, 126, 128, records and highlights steps for a troubleshooting (problem resolution) topic at hand (e.g., selected by the user), however, while other actions can be recorded as well. According to the example, the HD monitoring agent 124, 126, 128, can forward, via communications over the one or more networks 104, the recorded information (e.g., including the recorded actions corresponding to the one or more steps), to the information processing system 102 used by a HD representative. The HD representative, with access to the recorded information from the particular HD monitoring agent 124, 126, 128, can view the actions taken by the user, even if outside of specific steps in HD scripts (i.e., one or more sets of helpdesk problem resolution procedure steps) for the topic at hand. Various example ways this recorded information may be processed with the information processing system 102 used by the HD representative have been discussed above, and will be discussed in more detail below.

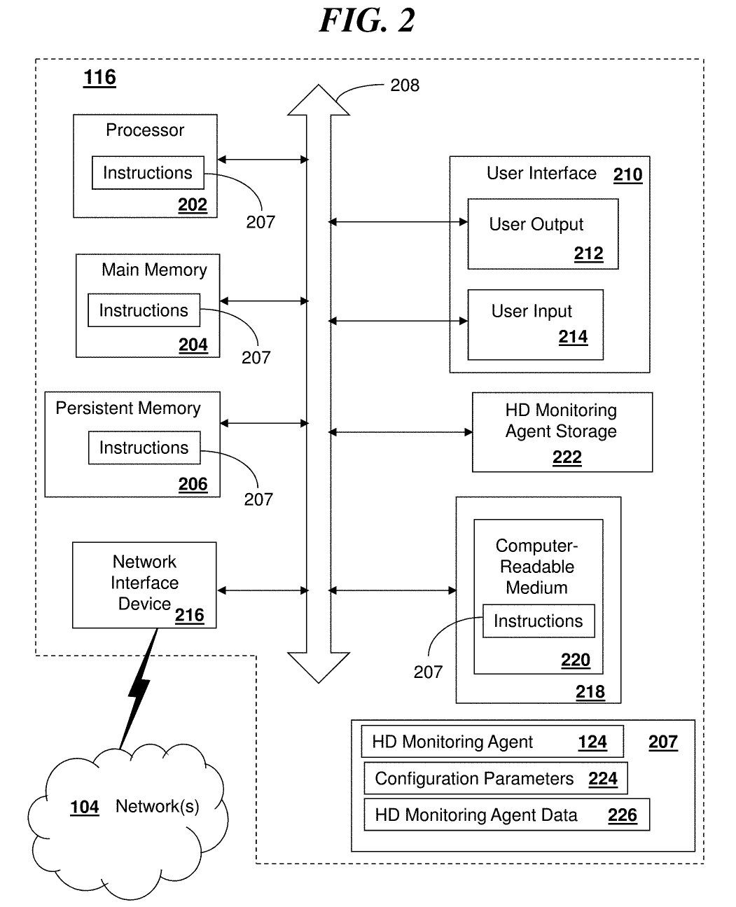

FIG. 2 is a block diagram illustrating an example of a wireless communication device (e.g., a mobile phone) 116 in the helpdesk monitoring communication system of FIG. 1, according to various embodiments of the present disclosure.

As shown in FIG.2, an information processing system 116, in this example being embodied in a wireless communication device such as a mobile phone, is communicatively coupled via the one or more networks 104 with the information processing system 102. According to this example, at least one processor 202, responsive to executing instructions 207, performs operations and is communicatively coupled with the HD Monitoring Agent 124. The HD Monitoring Agent 124 is communicatively coupled with an HD Monitoring Agent storage memory 222 via bus architecture 208, as shown. Recorded information that is being recorded by the HD Monitoring Agent 124 can be stored in this HD Monitoring Agent storage memory 222. The at least one processor 202 is communicatively coupled with main memory 204, persistent memory 206, and a computer readable medium 220.

The computer readable medium 220, according to the present example, is communicatively coupled with a reader/writer device 218 that is communicatively coupled via the bus architecture 208 with the at least one processor 202. The instructions 207, or any portion thereof, which can include instructions, configuration parameters, and data, may be stored in the computer readable medium 220, the main memory 204, the persistent memory 206, and in the processor's internal memory such as cache memory and registers, as shown.

The wireless communication device 116 includes a user interface 210 that comprises a user output interface 212 and a user input interface 214. Examples of elements of the user output interface 212 can include a display, a speaker, one or more indicator lights, one or more transducers that generate audible indicators, and a haptic signal generator. Examples of elements of the user input interface 214 can include a keyboard, a keypad, a mouse, a track pad, a touch pad, a microphone that receives audio signals. The received audio signals, for example, can be converted to electronic digital representation and stored in memory, and optionally can be used with voice recognition software executed by the processor 202 to receive user input data and commands.

A network interface device 216 is communicatively coupled with the processor 202 and provides a communication interface for the information processing system 100 to communicate via the one or more networks 104. The information processing system 116 can be communicatively coupled with the information processing system 102 via the one or more networks 104, as shown in FIG. 1.

The instructions 207, according to the present example, include instructions for the HD Monitoring Agent 124, and related configuration parameters 224 and data 226. It should be noted that any portion of the instructions 207 can be stored in a centralized information processing system or can be stored in a distributed information processing system, i.e., with portions of the system distributed and communicatively coupled together over one or more communication links or networks.

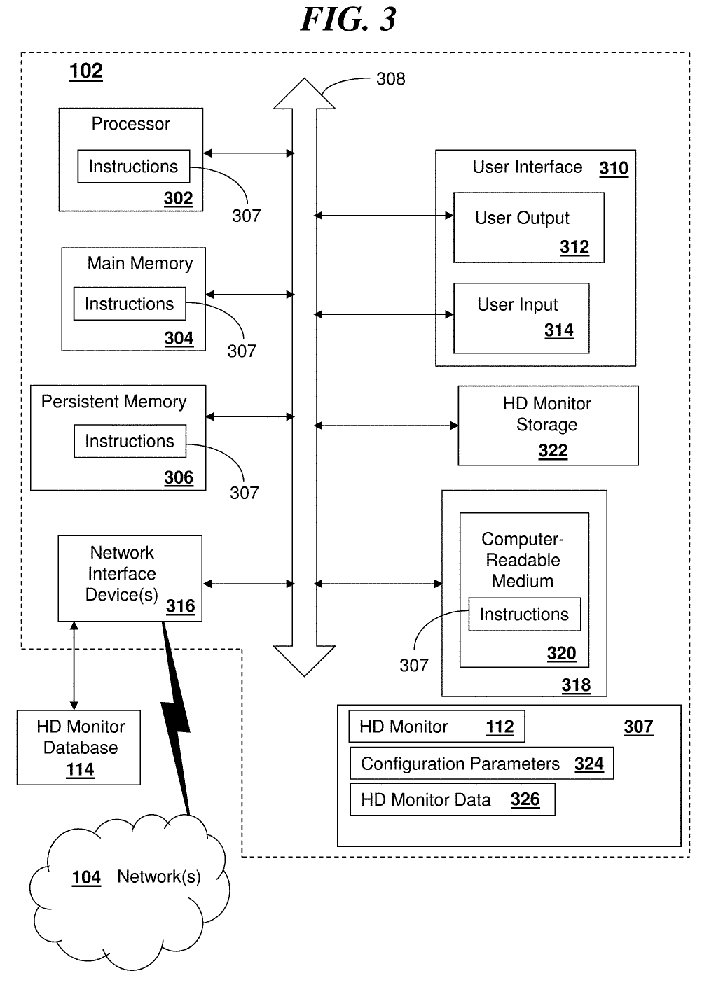

FIG. 3, according to the present example, illustrates an example of the information processing system 102 in the helpdesk monitoring communication system of FIG. 1, according to various embodiments of the present disclosure.

As shown in FIG. 3, the information processing system 102 can be communicatively coupled via the one or more networks 104 with the other one or more information processing systems 116, 120, 122, as shown in FIG. 1. According to this example, at least one processor 302, responsive to executing instructions 307, performs operations and is communicatively coupled with the HD Monitor 112. The HD Monitor 112 is communicatively coupled with an HD Monitor storage memory 322 via bus architecture 308, as shown. Recorded information that is received from one or more of the HD Monitoring Agents 124, 126, 128, can be stored in this HD Monitor storage memory 322. The at least one processor 302 is communicatively coupled with main memory 204, persistent memory 206, and a computer readable medium 220.

The computer readable medium 320, according to the present example, is communicatively coupled with a reader/writer device 318 that is communicatively coupled via the bus architecture 308 with the at least one processor 302. The instructions 307, or any portion thereof, which can include instructions, configuration parameters, and data, may be stored in the computer readable medium 320, the main memory 304, the persistent memory 306, and in the processor's internal memory such as cache memory and registers, as shown.

The information processing system 102 includes a user interface 310 that comprises a user output interface 312 and a user input interface 314. Examples of elements of the user output interface 312 can include a display, a speaker, one or more indicator lights, one or more transducers that generate audible indicators, and a haptic signal generator. Examples of elements of the user input interface 314 can include a keyboard, a keypad, a mouse, a track pad, a touch pad, a microphone that receives audio signals. The received audio signals, for example, can be converted to electronic digital representation and stored in memory, and optionally can be used with voice recognition software executed by the at least one processor 302 to receive user input data and commands.

A network interface device 316 is communicatively coupled with the processor 302 and provides a communication interface for the information processing system 102 to communicate via the one or more networks 104, as shown in FIG. 1. The information processing system 102, according to the present example, is also communicatively coupled with the HD Monitor Database 114 via the network interface device 316. The HD Monitor Database 114 can maintain history information regarding users, their information processing systems 116, 120, 122, the respective HD Monitoring Agents 124, 126, 128, and helpdesk scripts and other related information.

The instructions 307, according to the present example, include instructions for the HD Monitor 112, and related configuration parameters 324 and data 326. It should be noted that any portion of the instructions 307 can be stored in a centralized information processing system or can be stored in a distributed information processing system, i.e., with portions of the information processing system distributed and communicatively coupled together over one or more communication links or networks.

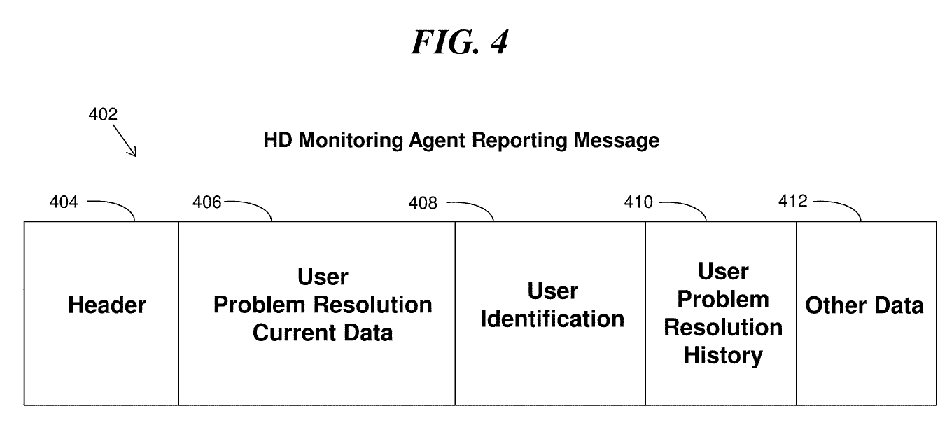

FIG. 4 is a block diagram of an example message 402 sent from an HD monitoring agent 124, 126, 128, to an HD monitor 112, according to various embodiments of the present disclosure.

The message 402 may be in the form of one or more message packets where each packet includes packet header information 404. This packet header information 404 is used by the one or more networks 104 and by the information processing systems 102, 116, 120, and 122, to facilitate communication of the message 402 in the helpdesk monitoring communication system 100. The packet header information 404 may include destination address, sender address, type of message packet, message packet identification, and other packet communication protocol information. The one or more packets are sent from the information processing system 116, 120, 122, destined for reception by the helpdesk information processing system 102.

The message 402 includes user-related information. For example, the user-related information can include user problem resolution current data 406. This data 406 may include current information recorded by the particular HD monitoring agent 124, 126, 128, while the respective user attempted to resolve a problem using the particular information processing system 116, 120, and 122. The message packet 104 includes user identification 408 which identifies the user (e.g., actual user identification, identification of particular HD monitoring agent 124, 126, 128, and/or particular user device) associated with the user problem resolution current data 406. The message 402, according to the present example, can include user problem resolution history 410 which is recorded and maintained by the particular HD monitoring agent 124, 126, 128, over an extended period of time (e.g., recorded over multiple user problem resolution sessions) and which is associated with the particular user identification information 408. The message packet 404 can include other data 412 that may be used by the HD Monitor 112 in connection with analyzing the current data 406 and the history data 410 for the particular user 408. For example, device configuration information, software features, hardware features, communication configuration, time information associated with the current data 406 and the history data 410 for the particular user 408, relevant background information about the particular user 408, and other information that may be useful for analyzing the current data 406 and the history data 410 for the particular user 408.

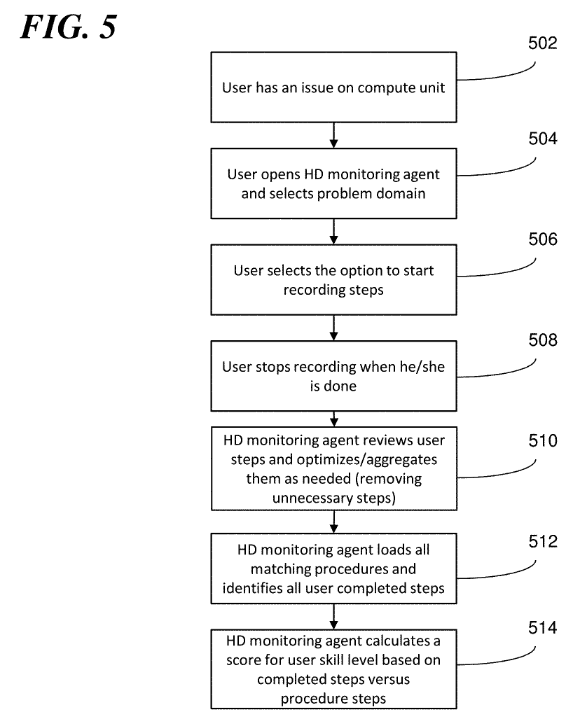

Referring to FIG. 5, the flow diagram illustrates an example operational sequence with the information processing system 116 in which a user uses the device 116 to resolve a problem issue (e.g., a problem resolution topic) with using the device 116. While using the device 116 the user has encountered an issue (e.g. a problem) with use of the device, at step 502. Then, at step 504, the user opens the particular HD monitoring agent 124 on the device 116 and selects, by providing user input 214 in the user interface 210, a problem resolution domain that the user understands to encompass the type of issue (problem) encountered while using the device 116. The user then selects (by providing user input 214 in the user interface 210), at step 506, the option to start recording actions/steps taken by the user. The HD monitoring agent 124 starts recording steps taken by the user while attempting to resolve a problem issue with using the device 116. Then, at step 508, the user stops recording when the user is done.

According to this example, the HD monitoring agent 124, at step 510, reviews user actions/steps taken by the user and optimizes and aggregates them as needed. The HD monitoring agent 124 removes unnecessary steps. The HD monitoring agent 124, at step 512, loads one or more matching HD problem resolution procedures (one or more HD scripts, i.e., one or more sets of relevant steps in a HD problem resolution procedure, within the problem resolution domain) and identifies all user completed steps in a HD problem resolution procedure determined to be relevant to solving the problem in the problem resolution domain.

The HD monitoring agent 124, at step 514, then calculates a score for the user skill level based on completed steps versus defined problem resolution procedure steps. For example, one approach to determining a skill level for a user regarding a particular topic may be to assign the highest skill level of all the steps already completed by the user. A second example approach to determining a skill level for the user may be to determine a skill level for the user based on how often the user, having a choice of a lower skill level step or an alternative higher skill level step, choses the higher skill level step in attempting to resolve the problem. According to a third example approach to determining a skill level for the user, when the user shows consistent successful completion of specific skill level steps, then the user is reward with that level of expertise in a particular topic. A combination of the approaches above may be taken to determine a skill level for the user. It should be understood that the above example approaches are only for illustration and there are other ways that a skill level may be determined for a user within the scope of the present disclosure.

Additionally, it should be noted that while the examples discussed above utilize the HD monitoring agent 124 to analyze the user steps taken and to calculate a score for the user skill level, in various embodiments the analyzing and calculating the score can be done by the HD monitor 112 based on information received from the HD monitoring agent 124. In various embodiments, a portion of the analyzing and calculating the score can be done by the HD monitoring agent 124 and the analyzing and calculating the score can be completed by the HD monitor 112. In various other embodiments, the HD monitor 112 performs any portion of the analyzing and calculating the score and then sends the information to the HD monitoring agent 124 which can, as needed, complete the analyzing and calculating the score. Then, the resulting information from the completed analyzing and calculating the score can be sent from the HD monitoring agent 124 to the HD monitor 112, such as by sending one or more messages 402 over the one or more networks 104. Any portion of the process discussed above can be automatically performed with either the HD monitoring agent 124 or the HD monitor 112, or a combination of both. The HD monitoring agent, accordingly, sends one or more messages including user-related information to the HD monitor 112, for presenting user-related information to a helpdesk representative for adapting helpdesk services. The user-related information can include, for example, identification of a user skill level score, identification of the set of relevant steps in a helpdesk problem resolution procedure that matches recorded user actions using the information processing system 116, and identification of one or more steps in the set of relevant steps that were completed by the user.

Optionally, the calculated skill level score may be displayed to the user at the wireless device 116 thereby informing the user of the determined skill level for the user in solving the problem. This information can indicate to the user a minimum skill level of a HD representative assisting the user (or who will assist upon the user calling the helpdesk). This information being provided to the user can reduce their apprehension that a skill level of a HD representative assisting (or who will assist upon calling the helpdesk) may be too low.

The user, according to certain embodiments, may be queried by a prompt displayed on the display of the wireless device 116 to agree or disagree with the determined skill level. The answer to such a query can be sent from the HD monitoring agent 124 to the HD monitor 112 and displayed on a display 312 of the HD information processing system 102 to the HD representative assigned to assist the user in solving the particular problem. This displayed information can be used by the HD representative. For example, it may indicate to the HD representative a level of increased apprehension by the user concerned that the skill level of assistance from the helpdesk may be too low. It could also indicate to the HD representative that, notwithstanding the skill level determined for the user, a higher level of skill for a HD representative may be more appropriate. That is, with this user feedback information, the HD representative can more quickly determine whether to escalate the problem resolution to another HD representative with a higher skill level.

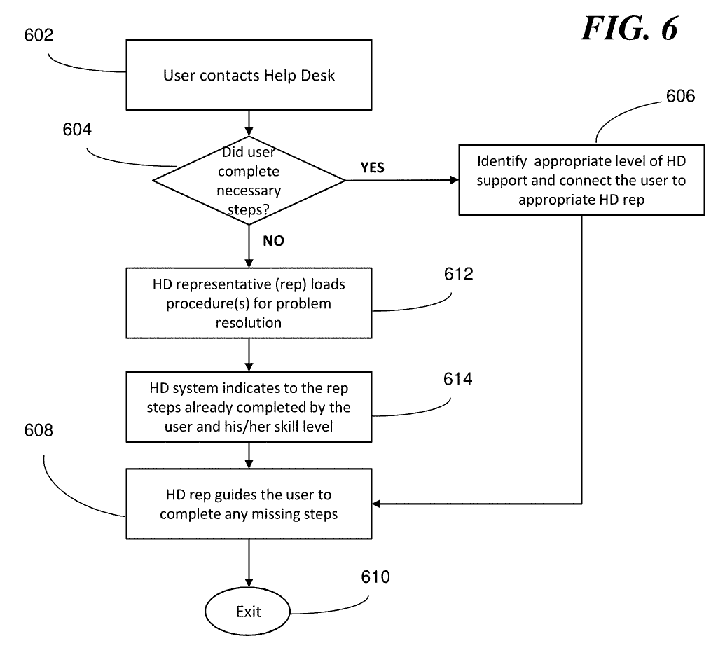

The flow diagram shown in FIG. 6 illustrates an example operational sequence with the HD information processing system 102 of FIG. 1. At step 602, the user contacts the helpdesk. Information recorded by the HD monitoring agent 124 is sent to the information processing system 102 and analyzed by the HD monitor 112. This recorded information can be sent in one or more message packets 402. The HD monitor 112 receives the one or more message packets 402 and stores the recorded information from the one or more message packets in the HD monitor storage memory 322. The HD monitor 112 analyzes the recorded information stored in the HD monitor storage 322, at step 604, and determines whether the user completed necessary/relevant steps. The HD monitor 112, according the example, stores in the HD monitor storage memory 322 a representation corresponding to each relevant step in the set of relevant steps of the determined helpdesk problem resolution procedure. If the HD monitor 112 determines, at step 604, that the user completed necessary/relevant steps, the HD monitor 112 stores in the HD monitor storage memory 322 a completed flag associated with each representation of the completed one or more relevant steps to indicate completed status of each of the one or more relevant steps. The HD monitor 112, according to the example, calculates a score for the user's skill level. This score calculation process has already been discussed above. The HD monitor 112 identifies the appropriate level of helpdesk support, at step 606, and connects the user to the appropriate helpdesk representative. The helpdesk representative, at step 608, guides the user to complete any missing steps. The operational sequence is then exited, at step 610.

On the other hand, if the user did not complete all the necessary steps, at step 604, then the helpdesk representative can load into the HD information processing system 102 one or more HD problem resolution procedures, at step 612. Of course, the set of procedures may already be stored in the HD monitor storage memory 322. The HD monitor 112, according the example, stores in the HD monitor storage memory 322 a representation corresponding to each relevant step in the set of relevant steps of the determined helpdesk problem resolution procedure. If the HD monitor 112 determines, at step 604, that the user completed necessary/relevant steps, the HD monitor 112 stores in the HD monitor storage memory 322 a completed flag associated with each representation of the completed one or more relevant steps to indicate completed status of each of the one or more relevant steps.

The HD monitor 112, according to the example, calculates a score for the user's skill level. This score calculation process has already been discussed above. The HD monitor 112 in the HD information processing system 102 determines the at least one helpdesk problem resolution procedure that matches the recorded user actions. The determined helpdesk problem resolution procedure is selected from a set of helpdesk problem resolution procedures within the problem resolution domain. The HD information processing system 102 indicates to the helpdesk representative the steps already completed by the user and his or her skill level, at step 614. For example, the HD information processing system 102 can present to the HD representative at least one relevant step of the set of relevant steps in the determined helpdesk problem resolution procedure, wherein the completed one or more steps are presented distinguished from the other steps in the set of relevant steps. More specifically, the HD information processing system 102 can automatically highlight those steps in the set of relevant steps that were completed by the user, and present representation of one or more of the completed steps to the HD representative. The HD information processing system 102, for example, can present the one or more completed steps by displaying the one or more completed steps highlighted on a display of the helpdesk information processing system. Additionally, according to certain embodiments, the HD information processing system 102 can present the determined user skill level to a user by displaying (such as on the display 312 of the HD information processing system 102) a representation of a score for the determined user skill level.

The HD representative benefits from viewing customized information about the end user while assisting the end user to resolve the problem which is the subject of the user's call to the helpdesk. This customized user-related information can include, but is not limited to, the 1) determined user skill level, and 2) one or more completed steps highlighted and distinguished from the other steps in the set of relevant steps in the determined helpdesk problem resolution procedure. This customized user-related information, for example, can be displayed on a display 314 of the helpdesk information processing system 102. With this customized user-related information presented to the helpdesk representative, the helpdesk representative more effectively guides the end user, at step 608, to complete any missing steps that were not completed yet by the end user. The operational sequence is then exited at step 610.

FIG. 7 shows an example of aggregation of user recorded actions with the wireless communication device 116. An example of the aggregation of user recorded actions was discussed with reference to FIG. 5, at step 510. Continuing with the example of FIG. 7, the leftmost rectangle 702 shows the user recorded actions recorded by the HD monitoring agent 124. The HD monitoring agent 124 then optimizes and aggregates, at the operational sequence 704, and the resulting aggregated and optimized user actions are shown in the rightmost rectangle 706. As can be seen in this example, the thirty user recorded actions were reduced by the HD monitoring agent 124 to twenty aggregated/optimized user actions which, having removed unnecessary actions/steps, provide the information to be analyzed by the HD monitoring agent 124 such as to identify all user completed steps in a set of relevant steps in a helpdesk problem resolution procedure and, optionally, to assign a skill level to the user, as will be discussed below.

As shown in FIG. 8, the HD monitoring agent 124, according to the present example, analyzes the steps taken by the user in attempting to solve the problem starting with the first step 802 and continuing through a sequence of steps to the last “fifteenth” step 804. In this example, the steps correspond to a helpdesk procedure (a script) to solve a personal computer connectivity issue. The HD monitoring agent 124 associates a skill level to each step taken by the user. This skill level association, according to one example, is determined by the HD monitoring agent 124 by comparing the particular recorded step taken by the user to one or more entries in a table stored in the HD monitoring agent storage memory 222. The table includes one or more table entries of possible steps that could be taken for a problem resolution domain according to steps in one or more predefined problem resolution scripts and skill levels assigned to each step by an expert in that problem resolution domain. For example, each entry in the table may include an identification of a particular step in a predefined script and associated with that particular step a skill level. There are other ways that the HD monitoring agent 124 could determine a skill level of each step taken by a user. As another example, a historical log of recorded steps taken by other users who have been recognized with particular skill levels could be analyzed in aggregate and a most likely skill level for taking a particular step in a script in a particular problem resolution domain could be determined from the analysis. The resulting determined skill levels for the steps of the script would be associated with each entry in the table.

In the example shown in FIG. 8, each step in the script that the user may take to solve a problem can range from a skill level of 1, at the lowest, to a skill level of four, at the highest. According to various embodiments, the range of skill levels may include more or less number of skill levels for steps in a problem resolution script (i.e., set of helpdesk procedure steps).

As can be seen in FIG. 8, the sixth step 806 in this script has an alternative step 808 that may be taken by the user. The skill level of the sixth step 806 is set to two while the alternative step 808 is set to a skill level of three which a more advanced user would take to accomplish the same procedure.

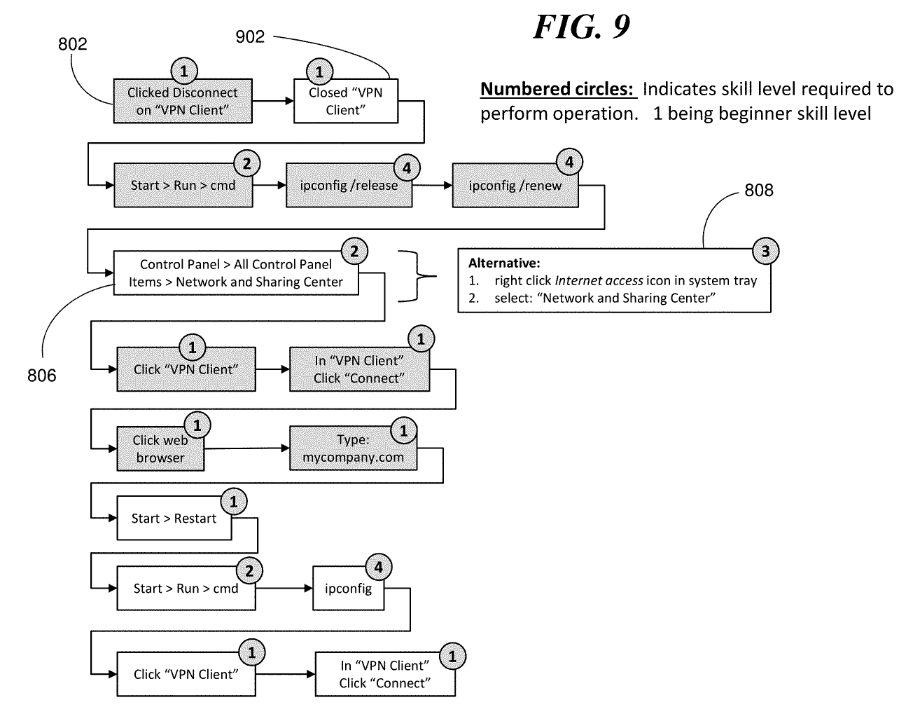

The HD monitoring agent 124, as shown in FIG. 9, monitors the steps taken by the user and tracks each step in the script that has been completed. For example, a list representing the sequence of relevant steps in this script may be stored in the HD monitoring agent storage 222. The HD monitoring agent 124, according to the example, sets a flag in the list for each step completed by the user. The user, at a point in time, has completed the first step 802, the third, fourth, and fifth steps, and the seventh, eighth, ninth, and tenth steps, in this script. These steps are flagged in the list stored in the HD monitoring agent storage 222. The user, as can be seen, has not completed the sixth step 806 or its alternative step 808.

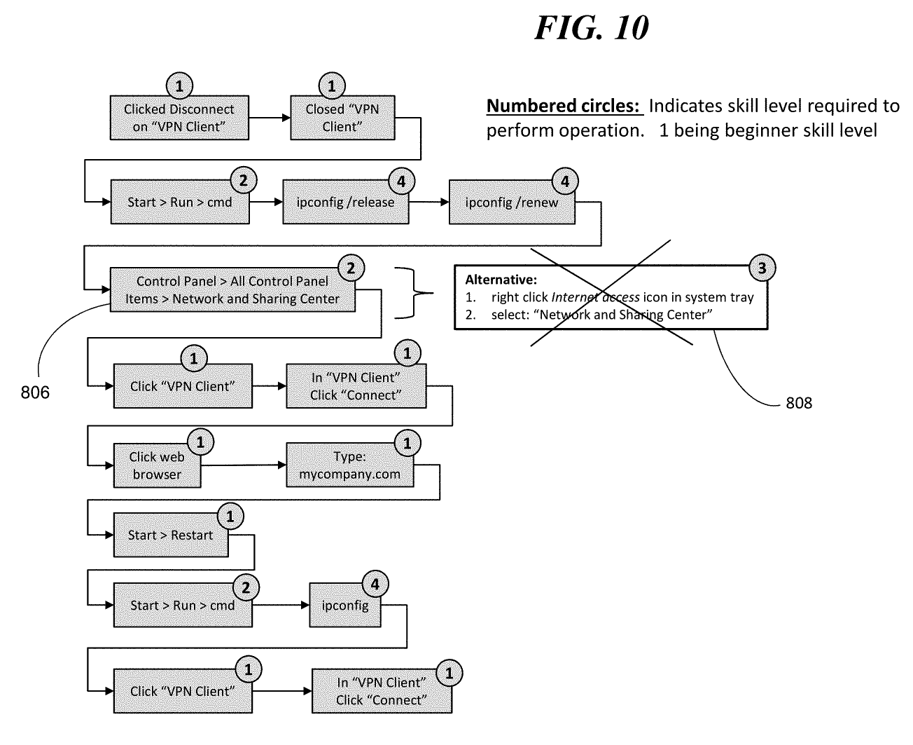

At a later point in time, as illustrated in FIG. 10, the user has completed all the steps in the script. Therefore, all the steps are flagged in the list stored in the storage 222. It should be noted that the user completed the sixth step 806 instead of taking the alternative step 808.

As has been discussed above such as with reference to FIG. 4, the HD monitoring agent 124 sends a message 402 to the HD monitor 112. The user problem resolution current data 406 would include the set of relevant steps for the helpdesk problem resolution procedure that was determined by the helpdesk monitoring agent 124 as matching the recorded user actions. This set of relevant steps, including user completed steps, was stored in the HD monitoring agent storage 222, as discussed above with reference to FIGS. 8 to 10. The HD monitor 112 can present to a helpdesk representative the current list of relevant steps taken by the user (e.g., a representation of completed steps) as received in the user problem resolution current data 406. A representation of the set of relevant steps in the script, highlighted such as in FIGS. 9 and 10 to distinguish the completed steps from the uncompleted steps, may be displayed on a display visible to a helpdesk representative assigned to assist this user to resolve the particular problem. The determined skill level of the user may also be displayed to the helpdesk representative. The information about the user, as discussed above, guide the HD representative to address the problem more effectively such as by avoiding steps already performed by the user. Additionally, the HD representative can communicate with the user at the skill level determined for the user by the HD monitoring agent 124. If, for example, the particular HD representative is determined to be below the skill level of the user, the problem resolution may be escalated (either manually by the HD representative or automatically by the HD information processing system 102) to handle the problem resolution procedure by another HD representative that more closely matches the higher skill level of the user. This will significantly increase user satisfaction in the overall experience solving a problem with the assistance of helpdesk resources.

It should be noted that the HD monitoring agent 124, according to various embodiments, may include in the message 402 a user problem resolution history 410. Such a user problem resolution history 410, as has been discussed above, can be recorded and maintained in the HD monitoring agent storage 222 by the HD monitoring agent 124 over an extended period of time, e.g., recorded over multiple user problem resolution sessions and associated with the particular user. This user problem resolution history 410, for example, may include several lists of various attempts by the user to solve the particular problem corresponding to the helpdesk procedure (a script) to solve the personal computer connectivity issue. The HD Monitor 112 may collect this additional user problem resolution history 410 information and display it, or an aggregate of the collection of information, on a display of the HD information processing system 102 to further assist the HD representative to determine which steps in a script should be taken to resolve the problem.

According to various embodiments of the present disclosure, a novel method is provided to allow a user to turn on a recording device that tracks/logs steps taken in problem determination, the transfer of those steps/log to a helpdesk agent, a system that analyzes the steps taken by the user to remove redundant troubleshooting steps to provide a faster, more user friendly method of helping to resolve the problem.

According to various embodiments, a HD monitoring agent 124, 126, 128, is communicatively coupled with a HD monitor 112, to infer and determine a highest skill level of a caller to a helpdesk, based on monitored/recorded steps performed by the helpdesk caller to solve a problem that is the subject of the call. Each step has a skill level rating in the helpdesk information processing system 102. When the user shows consistent successful completion of specific level steps, then the helpdesk agent (or automated system) is able to reward him/her with that level of expertise in a topic.

According to certain embodiments, a user can turn on a recording device at the user's device that tracks/logs (records) steps taken in problem determination. For example, the user can use the user interface 210 to submit a request for the HD monitoring agent 124 to start selectively recording user actions at the user device. The information processing system 116 starts selectively recording user actions and capturing those recorded user actions, for example, in a log in memory 204. The captured recorded user actions are transferred to the helpdesk monitoring agent 124 at the user device 116, or can be sent by the helpdesk monitoring agent 124 from the information processing system 116 to a helpdesk monitor 112 at a HD information processing system 102 that can be remotely located from the information processing system 116. The helpdesk monitor 112 at the HD information processing system 102 can be communicatively coupled with the information processing system 116 over the one or more networks 104.

According to the example, the helpdesk monitoring agent 124, or in certain embodiments the helpdesk monitor 112, analyzes the user actions and the relevant steps in a HD script that matches the user actions to determine which steps in the script were taken (completed) by the user. In this way, the helpdesk monitor 112 can remove redundant troubleshooting steps from the HD script to guide a helpdesk representative to provide faster, more user friendly, assistance to an end user to resolve the problem.

In one scenario, according to the example, a user could begin recording their own troubleshooting ticket (by turning on the HD monitoring agent 124 that runs on the information processing system 116, e.g., on a personal computer or a mobile phone, etc.), even before the user decides to call a helpdesk resource. The user may not know yet whether they need to call the helpdesk resource because the user may themselves solve the problem without assistance from a helpdesk representative. When the user determines they cannot resolve the issue (problem) without assistance, and decides to call the helpdesk, the user then can stop the recording (e.g., by entering user input to stop the HD monitoring agent 124 from further recording user actions) and then can send/upload/allow the HD monitoring agent 124 to collect the recorded user actions (troubleshooting items) from the user's information processing system 116 and send user-related information via one or more messages 402 (which can include one or more of the following: the collected recorded user actions, aggregated and optimized user actions matched to completed steps of a helpdesk script, and a user skill level score in solving the problem). The one or more messages 402 including the user-related information can be sent before or contemporaneously with the user calling the helpdesk resource seeking assistance to solve the problem. In this way, the user can proactively send user-related information to a helpdesk information processing system 102 to guide a helpdesk representative to provide faster, more user friendly, assistance to the end user to resolve the problem that is the subject of the call to the helpdesk resource.

According to various embodiments, the helpdesk monitor compares the recorded end users steps (or an aggregate reduced set of end user steps based on the recorded steps) to a set of steps recognized by a helpdesk as the official/best practices way to accomplish a task. Further the helpdesk monitor determines to what level of expertise the end user should be classified.

According to various embodiments, a HD monitoring agent at the user's device selective records user actions, which ignores user actions except those actions which relate to a helpdesk script. In certain embodiments, the HD monitoring agent selectively records user actions on an end users device (e.g., a user's PC or mobile phone) based on a helpdesk script that is in a problem resolution domain that the user understands to encompass the type of issue encountered while using the device 116. This recording procedure more accurately captures a user's actions taken to try to resolve a problem that is the subject of a call to a helpdesk resource.

According to various embodiments, a HD monitoring agent at a user's device, and/or a HD monitor at a HD information processing system, can develop an inference of (e.g., determine) a user's skill level solving a problem that is the subject of a call to the helpdesk, based on the user's actions in solving the problem, and provides an automatic adjustment of the appropriate helpdesk script based on those actions.

Non-Limiting Examples

The present invention may be a system, a method, and/or a computer program product. The computer program product may include a computer readable storage medium (or media) having computer readable program instructions thereon for causing a processor to carry out aspects of the present invention.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer readable program instructions described herein can be downloaded to respective computing/processing devices from a computer readable storage medium or to an external computer or external storage device via a network or networks, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems), and computer program products according to embodiments of the invention. It will be understood that each block of the flowchart illustrations and/or block functional diagrams, and combinations of blocks in the flowchart illustrations and/or block functional diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or functional block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the computer readable storage medium is shown in an example embodiment to be a single medium, the term “computer readable storage medium” should be taken to include a single medium or multiple media (e.g., a centralized or distributed database, and/or associated caches and servers) that store the one or more sets of instructions. The term “computer-readable storage medium” shall also be taken to include any non-transitory medium that is capable of storing or encoding a set of instructions for execution by the machine and that cause the machine to perform any one or more of the methods of the subject disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a computer-readable storage medium, as listed herein and including art-recognized equivalents and successor media, in which the software implementations herein are stored.

Although the present specification may describe components and functions implemented in the embodiments with reference to particular standards and protocols, the disclosure is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor is illustrated for an information processing system, information processing systems with multiple CPUs or processors can be used equally effectively. Various embodiments of the present disclosure can further incorporate interfaces that each includes separate, fully programmed microprocessors that are used to off-load processing from the processor. An operating system (not shown) included in main memory for the information processing system may be a suitable multitasking and/or multiprocessing operating system, such as, but not limited to, any of the Linux, UNIX, Windows, and Windows Server based operating systems. Various embodiments of the present disclosure are able to use any other suitable operating system. Various embodiments of the present disclosure utilize architectures, such as an object oriented framework mechanism, that allows instructions of the components of operating system (not shown) to be executed on any processor located within the information processing system. Various embodiments of the present disclosure are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device (which may also be referred to as a wireless device), a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A method for customizing helpdesk services provided to an end user according to a user's skill level, the method comprising:
determining, with a processor communicatively coupled to a memory, a problem resolution domain corresponding to a user of an information processing system solving a problem associated with using the information processing system;
selectively recording user actions by storing in the memory a set of representations of the recorded user actions that are determined to be within the problem resolution domain and that occur with the information processing system being used by the user to solve a problem associated with using the information processing system;
determining, based on the recorded user actions, a helpdesk problem resolution procedure that matches the recorded user actions, the determined helpdesk problem resolution procedure being selected from a set of helpdesk problem resolution procedures within the problem resolution domain, each of the set of helpdesk problem resolution procedures comprising a set of relevant steps to be completed for solving a problem within the problem resolution domain, a representation corresponding to each relevant step in the set of relevant steps of the determined helpdesk problem resolution procedure, being stored in a first memory of a first information processing system;
aggregating the recorded user actions by converting the recorded user actions into completed one or more steps in a set of relevant steps in the determined helpdesk problem resolution procedure for solving a problem within the problem resolution domain, a completed flag being associated with each representation of the completed one or more steps stored in the first memory to indicate completed status of each of the one or more steps; and
presenting to a helpdesk representative at least one relevant step of the set of relevant steps in the determined helpdesk problem resolution procedure, wherein the completed one or more steps being presented distinguished from the other steps in the set of relevant steps.

2. The method of claim 1, wherein the information processing system comprises a wireless communication device, and wherein the determining a problem resolution domain comprises receiving user input from a user of the wireless communication device, the user input comprising identification of the problem resolution domain.

3. The method of claim 1, wherein the selectively recording user actions is in response to receiving a request to start selectively recording user actions by receiving user input from a user of the information processing system.

4. The method of claim 1, further comprising:
analyzing, with a first processor of the first information processing system and which is communicatively coupled with the first memory, the set of relevant steps in the determined helpdesk problem resolution procedure including those one or more steps that are determined to be completed by the user, and automatically identifying a user skill level based on measuring accuracy of recorded user actions in performing the set of relevant steps and based on percentage of overlap of the completed one or more steps relative to all the relevant steps in the determined helpdesk problem resolution procedure;
adapting helpdesk services corresponding to the determined helpdesk problem resolution procedure based at least on the determined user skill level by automatically highlighting those steps in the set of relevant steps that were completed by the user, thereby resulting in a modified helpdesk problem resolution procedure; and
displaying on a display of a helpdesk information processing system the modified helpdesk problem resolution procedure, thereby presented to a helpdesk representative.

5. The method of claim 4, further comprising:
displaying on the display of the helpdesk information processing system a representation of a score for the determined user skill level.

6. The method of claim 4, further comprising:
displaying on the display of the information processing system a representation of a score for the determined user skill level to inform the user of the determined user skill level for the user.

7. The method of claim 4, wherein the first information processing system, the first processor, and the first memory, are respectively the information processing system, the processor, and the memory, that are being used by the user to solve a problem associated with using the information processing system.

8. The method of claim 4, wherein the first information processing system, the first processor, and the first memory, are respectively the helpdesk information processing system, and a processor and a memory of the helpdesk information processing system, the helpdesk information processing system being separate from, and communicatively couple with, the information processing system being used by the user to solve a problem associated with using the information processing system.

9. The method of claim 1, wherein the determining a helpdesk problem resolution procedure is performed with a helpdesk monitoring agent communicatively coupled with the processor and the memory and operating in the information processing system.

10. The method of claim 9, wherein the helpdesk monitoring agent being communicatively coupled with a helpdesk monitor operating in a helpdesk information processing system that is separate from, and communicatively coupled over one or more networks with, the information processing system; and the method further comprising:
the helpdesk monitoring agent sending, over the one or more networks, one or more messages destined for reception by the helpdesk monitor, the one or more messages comprising identification of the helpdesk problem resolution procedure that was determined by the helpdesk monitoring agent as matching the recorded user actions.

11. The method of claim 10, wherein the one or more messages comprising identification of a set of relevant steps in the helpdesk problem resolution procedure that were determined by the helpdesk monitoring agent to have been completed based on the recorded user actions.

12. The method of claim 11, wherein the helpdesk information processing system is the first information processing system, and the helpdesk monitor being communicatively coupled with the first memory, the method further comprising:
the helpdesk monitor storing in the first memory each representation corresponding to each relevant step in the set of relevant steps of the determined helpdesk problem resolution procedure;
the helpdesk monitor storing in the first memory a completed flag associated with each representation of completed one or more steps in the set of relevant steps to indicate completed status of each of the one or more steps; and wherein
the presenting comprising displaying on a display of the helpdesk information processing system one or more of the steps in the set of relevant steps in the determined helpdesk problem resolution procedure, wherein the completed one or more steps being displayed distinguished from the other steps in the set of relevant steps.

13. An information processing system capable of customizing helpdesk services provided to an end user according to a user's skill level, the information processing system comprising:
memory;
persistent memory for storing data and computer instructions;
at least one processor, communicatively coupled with the memory and the persistent memory; and
a helpdesk monitoring agent, communicatively coupled with the processor, the memory, and the persistent memory, wherein the helpdesk monitoring agent being responsive to receiving user input indicating a user request to start selectively recording user actions and wherein the processor being responsive to executing the computer instructions, the processor performing the method comprising:
determining, with the processor, a problem resolution domain corresponding to a user of the information processing system solving a problem associated with using the information processing system;
selectively recording the user's actions by storing in the memory a set of representations of the recorded user actions that are determined to be within the problem resolution domain and that occur with the information processing system being used by the user to solve a problem associated with using the information processing system;
determining, based on the recorded user actions, a helpdesk problem resolution procedure that matches the recorded user actions, the determined helpdesk problem resolution procedure being selected from a set of helpdesk problem resolution procedures within the problem resolution domain, each of the set of helpdesk problem resolution procedures comprising a set of relevant steps to be completed for solving a problem within the problem resolution domain, a representation corresponding to each relevant step in the set of relevant steps of the determined helpdesk problem resolution procedure being stored in the memory;
aggregating the recorded user actions by converting the recorded user actions into completed one or more steps in a set of relevant steps in the determined helpdesk problem resolution procedure for solving a problem within the problem resolution domain, a completed flag being associated with each representation of the completed one or more steps stored in the memory to indicate completed status of each of the one or more steps; and
sending one or more messages destined for reception by a helpdesk monitor in a helpdesk information processing system being separate from, and located across one or more networks relative to, the information processing system, the one or more messages including user-related information for presenting to a helpdesk representative for adapting helpdesk services corresponding to the determined helpdesk problem resolution procedure provided by the helpdesk representative to the user, the user-related information comprising:
identification of the set of relevant steps in the determined helpdesk problem resolution procedure that matches the recorded user actions; and
identification of one or more steps in the set of relevant steps that were completed by the user.

14. The information processing system of claim 13, wherein the processor responsive to executing the computer instructions, performing the method further comprising:
analyzing, with the processor, the set of relevant steps in the determined helpdesk problem resolution procedure including those one or more steps that are determined to be completed by the user, and automatically determining a user skill level for the user based on measuring accuracy of recorded user actions in performing the set of relevant steps and based on percentage of overlap of the completed one or more steps relative to all the relevant steps in the determined helpdesk problem resolution procedure; and wherein the user-related information in the one or more messages comprising:
identification of the determined user skill level for presenting the determined user skill level to the helpdesk representative for adapting helpdesk services corresponding to the determined helpdesk problem resolution procedure.

15. The information processing system of claim 14, wherein the processor responsive to executing the computer instructions, performing the method further comprising:
displaying on a display of the information processing system a representation of a score for the determined user skill level to inform the user of the determined user skill level for the user.

16. A computer readable storage medium, comprising computer instructions which, responsive to being executed by at least one processor, cause the processor to perform operations for customizing helpdesk services provided to an end user according to a user's skill level, the operations comprising:
determining, with the processor being communicatively coupled to a memory of an information processing system, a problem resolution domain corresponding to a user of the information processing system solving a problem associated with using the information processing system;
selectively recording user actions by storing in the memory a set of representations of the recorded user actions that are determined to be within the problem resolution domain and that occur with the information processing system being used by the user to solve a problem associated with using the information processing system;
determining, based on the recorded user actions, a helpdesk problem resolution procedure that matches the recorded user actions, the determined helpdesk problem resolution procedure being selected from a set of helpdesk problem resolution procedures within the problem resolution domain, each of the set of helpdesk problem resolution procedures comprising a set of relevant steps to be completed for solving a problem within the problem resolution domain, a representation corresponding to each relevant step in the set of relevant steps of the determined helpdesk problem resolution procedure being stored in the memory;
aggregating the recorded user actions by converting the recorded user actions into completed one or more steps in a set of relevant steps in the determined helpdesk problem resolution procedure for solving a problem within the problem resolution domain, a completed flag being associated with each representation of the completed one or more steps stored in the memory to indicate completed status of each of the one or more steps; and
sending one or more messages destined for reception by a helpdesk monitor in a helpdesk information processing system being separate from, and located across one or more networks relative to, the information processing system, the one or more messages including user-related information for presenting to a helpdesk representative for adapting helpdesk services corresponding to the determined helpdesk problem resolution procedure provided by the helpdesk representative to the user, the user-related information comprising:
identification of the set of relevant steps in the determined helpdesk problem resolution procedure that matches the recorded user actions; and
identification of one or more steps in the set of relevant steps that were completed by the user, for presenting to the helpdesk representative the completed one or more steps distinguished from the other steps in the set of relevant steps.

17. The computer readable storage medium of claim 16, wherein the processor performed operations further comprising:
analyzing, with the processor, the set of relevant steps in the determined helpdesk problem resolution procedure including those one or more steps that are determined to be completed by the user, and automatically determining a user skill level for the user based on measuring accuracy of recorded user actions in performing the set of relevant steps and based on percentage of overlap of the completed one or more steps relative to all the relevant steps in the determined helpdesk problem resolution procedure; and wherein the user-related information in the one or more messages comprising:
identification of the determined user skill level for presenting the determined user skill level to the helpdesk representative for adapting helpdesk services corresponding to the determined helpdesk problem resolution procedure.

18. The computer readable storage medium of claim 17, wherein the processor performed operations further comprising:
displaying on a display of the information processing system a representation of a score for the determined user skill level to inform the user of the determined skill level for the user.

19. The computer readable storage medium of claim 16, wherein the selectively recording user actions is in response to receiving a request to start selectively recording user actions by receiving user input from a user of the information processing system.

20. The computer readable storage medium of claim 16, wherein the information processing system comprises a wireless communication device, and wherein the determining a problem resolution domain comprises receiving user input from a user of the wireless communication device, the user input comprising identification of the problem resolution domain.
